(19) United States
(12) Patent Application Publication
(10) Pub. No.: US 2025/0178941 A1
(43) Pub. Date: Jun. 5, 2025

(54) SYSTEM AND METHOD FOR TREATING WASTE WATER AND PROCESS WATER

(71) Applicant: Amerapex Corporation, Houston, TX (US)

(72) Inventors: Charles Mitchell MEANS, Houston, TX (US); Remy KALAI, Houston, TX (US); Steve WALKER, Houston, TX (US)

(73) Assignee: Amerapex Corporation, Houston, TX (US)

(21) Appl. No.: 18/970,435

(22) Filed: Dec. 5, 2024

Related U.S. Application Data
(60) Provisional application No. 63/606,529, filed on Dec. 5, 2023.
(60) Provisional application No. 63/611,060, filed on Dec. 15, 2023.

(51) Int. Cl. C02F 9/00; C02F 1/00; C02F 1/28; C02F 1/34; C02F 1/40; C02F 1/463; C02F 1/48; C02F 1/52; C02F 1/78; C02F 103/02; C02F 103/38

(52) U.S. Cl. CPC C02F 9/00; C02F 1/004; C02F 1/283; C02F 1/34; C02F 1/40; C02F 1/463; C02F 1/484; C02F 1/5281; C02F 1/78; C02F 2103/023; C02F 2103/38

(57) ABSTRACT

Solids can be removed from waste water and process water using a system including a magnetic flux chamber, a phase separator, and a filtration system by employing chemical injection of select additives. This system can remove solids having an average diameter of less than 0.1 microns (0.0001 mm). Select media may also be employed to enhance solids removal process water.

### CROSS-REFERENCE TO RELATED APPLICATIONS

This application claims priority to and the benefit of U.S. Provisional Patent Application No. 63/606,529 filed on Dec. 5, 2023 (Docket No. AMPX-1001), and also claims priority to and the benefit of U.S. Provisional Patent Application No. 63/611,060 filed on Dec. 15, 2023 (Docket No. AMPX-1002). This application incorporates the provisional applications by reference in its entirety into this document as if fully set out at this point.

### BACKGROUND OF THE INVENTION

### Field of the Invention

The invention relates to the treatment of water. The invention particularly relates to water treatments where the water is process or waste water.

### Background of the Art

Separating multiphase fluids has long been an issue in many fields. For example, in the field of wastewater treatment, separating solids from water can be problematic, especially if the solids are very small or in the form of an emulsion. For example, in the production of oil and gas, “produced fluids” are primarily water with hydrocarbons and solids. In this three-phase liquid, it would be desirable to separate the phases in order to recycle and/or dispose of the produced water components.

In the production of chemicals, often at the end of processes to purify product chemicals, water is used as a solvent and/or extractant. Once the desired products have been removed from the water, the remaining water is too contaminated to be recycled and must be disposed. It would be desirable in the art of producing chemicals to remove the contaminates and then safely dispose of the water as effluent or reuse the water by recycling it into the plant process streams.

Employing cavitation to facilitate such separations is known in the art. U.S. Pat. No. 5,482,629 to Rippetoe, et al., discloses using a combination of a copper nickel alloy reactor consisting of two spaced apart concentric elongated metal cylinders wherein the inner cylinder has a multiplicity of radial bored holes in the space between the inner cylinder and outer cylinder has the subject copper nickel alloy surface. Liquids are pumped into the inner cylinder at a comparatively high pressure forcing the liquid through the holes to produce jets. Interaction of the jets of liquid and the alloy are reported to improve phase separations. This patent is incorporated herein by reference in its entirety.

It would be desirable in the art to be able to treat liquids to improve separation of multiphase components.

### SUMMARY OF THE INVENTION

In one aspect, the invention is a solids removal system for use with waste and process water including: at least one magnetic flux chamber; at least one phase separator configured to capture lighter than water materials and interfacial rag materials; at least one chemical injection apparatus; and a filtration system employing a filtering media, where the at least one magnetic flux chamber, at least one phase separator, at least one chemical injection apparatus and filtration system is configured to remove solids from the waste water and process water.

In another aspect the invention is a method for removing solids from waste water or process water including: employing a magnetic flux chamber within an aqueous process stream to separate at least some solids from the aqueous process stream thereby creating a polarized stream; introducing the polarized stream into a phase separator and diverting any lighter than water materials and rag from the polarized stream; injecting water treatment chemicals into the aqueous process stream at at least one point to improve solids and/or lighter than water removal; and passing the treated aqueous process stream through a filter system employing a media sufficient to remove any solids larger than 0.1 microns (0.0001 mm).

In yet another aspect, the invention is a solids removal system for use with waste and process water including: an electrocoagulation device; at least one ozone injector; an oxidizing cavitation device; and a filtration system employing a filtering media, wherein the electrocoagulation device, at least one ozone injector, oxidizing cavitation device, and filtration system is configured to remove solids and other contaminants from the process water.

In another aspect the invention is a solids removal process for use with process water comprising: introducing a process water stream into an electrocoagulation device; directing an effluent from the electrocoagulation device an oxidizing cavitation device; and directing the effluent from the oxidizing cavitation device into a filtration system employing a filtering media, wherein: ozone is injected into the process at at least one point; and the effluent from the filtration system is recycled into a process where the process is the same or different from that which the process water was initially diverted.

### BRIEF DESCRIPTION OF THE DRAWINGS

The above and other features and advantages of the present invention will become more apparent by describing in detail embodiments thereof with reference to the attached drawings in which:

FIG. 1 illustrates a first configuration of an embodiment of the invention particularly useful for treating effluent from a polyolefin plant;

FIG. 2 illustrates a second embodiment of the invention similar to that of FIG. 1 except it includes a second filtration unit;

FIG. 3 illustrates a third embodiment similar to that of FIG. 1 except the point of introduction of the chemical additives is changed; and

FIG. 4 illustrates an embodiment of the invention particularly useful for treating process water.

### DESCRIPTION OF THE PREFERRED EMBODIMENTS

One embodiment of the application is removing solids from waste water and process water using a system including a magnetic flux chamber, a phase separator, and a filtration system by employing chemical injection of select additives. This system can remove solids having an average diameter of less than 0.1 microns. Select media may also be employed to enhance solids removal.

The magnetic flux chamber useful with the application is any that can introduce at least 0.5 Tesla magnetic flux into water flowing through it. In some embodiments, the magnetic flux is at least 0.8 Tesla. In some others it is at least 1.5 Tesla. One of ordinary skill in the art will well know how to optimize the degree of magnetic flux with energy costs and impact on the waste water stream being treated.

The phase separators useful with the application include but are not limited to those which can take a multiphase water system and separate it into a water phase, a rag phase, a light phase (usually hydrocarbons) and in some embodiments, a gas phase.

The type of phase separators useful with the embodiments of the application include those known to those of ordinary skill in the art and include but are not limited to those employing electrocoagulation as well as density separation. Use of vacuum and pressure systems is also within the scope of the application.

The system also employs electrocoagulation units. The disclosure of U.S. Pat. No. 9,108,160 to Weimers, et al., which is incorporated herein in its entirety by reference, discloses one such unit. The reference provides methods for combining electrocoagulation and membrane aeration treatment stages in an effluent treatment array to provide enhanced electrocoagulation processing. The method of this invention are exemplarily embodied in apparatus providing a unified installation reducing maintenance floor space requirements. The apparatus is designed for co-extensive utilization of components and efficient, durable operation. Any electrocoagulation unit known to be useful for treating waste or process water by those of ordinary skill in the art can be employed with the systems and methods of the application.

The oxidizing cavitation devices useful with the methods of the application include those such as the one disclosed in U.S. Pat. No. 5,482,629 to Rippetoe, already incorporated herein by reference. Another such device is one where waste or process water is subject to cavitation which can cause oxidization of organic components by creating transient high temperatures and pressures. In some embodiments, this can be further augmented by use of ultrasound. Any oxidizing cavitation component known to those of ordinary skill in the art can be employed with the systems and methods of the application.

The filtration systems of the application include both those that employ a media, such as granular filtration media, as well as those that employ centrifugal force. In one embodiment, the filter media is a special ceramic media such as Ceraflow-70, the specifications for which may be found in the Table.

TABLE
PRODUCT SPECIFICATIONS

| Parameter | Ceraflow-70 |
|---|---|
| Effective Size | 0.15 mm-0.25 mm (60-80 Mesh) |
| Uniformity Coefficient | <1.4 (1.25 Typical) |
| Density | 106 lbs/ft³ (1.7 g/cm³) |
| Recommended Backwash Rate | 8 gpm/ft² (18.3 m/h) |
| Acid Solubility | <1% (0.1% typical) |

Performance testing by Dr. James A [symbol] , Associate Professor, UNC Charlotte. [symbol]
indicates data missing or illegible when filed

In other embodiments of the application other media may also be used. One such alternate media is carbon granules. Another is porous metal. Any porous material having a suitable pore size known to be useful to those of ordinary skill may be used with the embodiments of the application. One exception to this would be bag or cartridge filters which are inferior because they are single use which results in excessive operating costs and disposal issues.

In the practice of the method of the application chemical injection may be employed. Chemicals may be introduced at any point in the method of the application. The chemicals may be introduced by pumping, gravity feeding, or any other method known to those of ordinary skill in the art to be useful.

The chemicals which may be employed include but are not limited to coagulants, oxidants, surfactants, and the like. Any chemical known to useful in treating waste water may be employed with the methods of the application. For example, for oxidants, oxygen, percarbonate as sodium percarbonate; peroxymonosulfate, hydrogen peroxide, ozone, singlet oxygen, and importantly, sulfate, hydroxyl, and carbonate radicals may be employed in some embodiments.

Coagulants useful with the systems of the application include but are not limited to alum, alumina, aluminum chloralhydrate, aluminum sulfate, calcium oxide, iron (sulfur) iron sulfate, magnesium sulfate, polyacrylamide, sodium aluminate, poly aluminum chloride, and sodium silicate.

A surfactant is an amphiphilic substance that has both a hydrophilic group that is easily soluble in water and a hydrophobic group that is easy to dissolve in oil in one molecule. It is a compound that significantly changes the properties of the interface by lowering the free energy. Surfactants are largely divided into chemically synthesized chemical surfactants and natural surfactants. Chemical surfactants include anionic surfactants, cationic surfactants, amphoteric surfactants, nonionic surfactants, and polymeric surfactants. Natural surfactants include lecithin, lanolin, saponins, and biosurfactants extracted from microorganisms. Emulsion polymers having surfactant properties can also be used. Surfactants useful with the systems of the application include but are not limited to these but also include any known to be useful in treating waste water or process water.

The systems of the application can be employed where the waste water is contaminated with very fine particulate matter. For example, in some embodiments, the waste produced has no particulates greater than 0.1 microns in diameter. In other embodiments, the waste produced has no particulates greater than 0.05 microns in diameter. And in still other embodiments, the waste produced has no particulates greater than 0.01 microns in diameter.

One embodiment which is particularly useful is treating the effluent from a polyolefin process. Most polyolefins, such as polyethylene, polypropylene, and copolymers thereof, are prepared by contacting an olefin or mixture of olefins with a catalyst under conditions to promote polymerization. In modern polyolefin production, the most common catalysts are Ziegler Natta Catalysts and Metallocene catalysts.

The key difference between Ziegler-Natta catalysts and metallocene catalysts is that Ziegler-Natta catalysts are typically heterogeneous with multiple active sites, leading to broader molecular weight distributions in the produced polymer, while metallocene catalysts are homogeneous with a single type of active site, allowing for much greater control over the polymer structure and properties; essentially, metallocene catalysts offer more precise polymer design compared to Ziegler-Natta catalysts.

Both types of catalysts are made with transition metal catalyst such as titanium, vanadium, chromium, and zirconium. Aluminum is very frequently used. Other polyolefin catalysts may include Zinc and copper. While not wishing to be bound by any theory, it is believed that especially with waste water from a polyolefin unit, the high intensity magnetic field used with the methods of the application interact with such metals and contribute to improved removal of polymer waste particles seen with embodiments of the application.

In some embodiments, Ozone injection is an important part of the process of the application. Ozone injection as well as generation may be performed by any means known to be useful to those of ordinary skill in the art. Desirably, the ozone gas will be introduced with very small bubble size to increase the effectiveness of the ozone.

The systems and methods of the application may also be used with process water. Process water is used for processes such as power generation (aka cooling tower water) and steam generation.

In some of the embodiments of the method of the application, the method of the application removed more than 99.0% of total suspended solids from process water. In other embodiments, the method of the application removed more than 99.5% of total suspended solids from process water. And in other embodiments, the method of the application removed more than 99.8% of total suspended solids from process water.

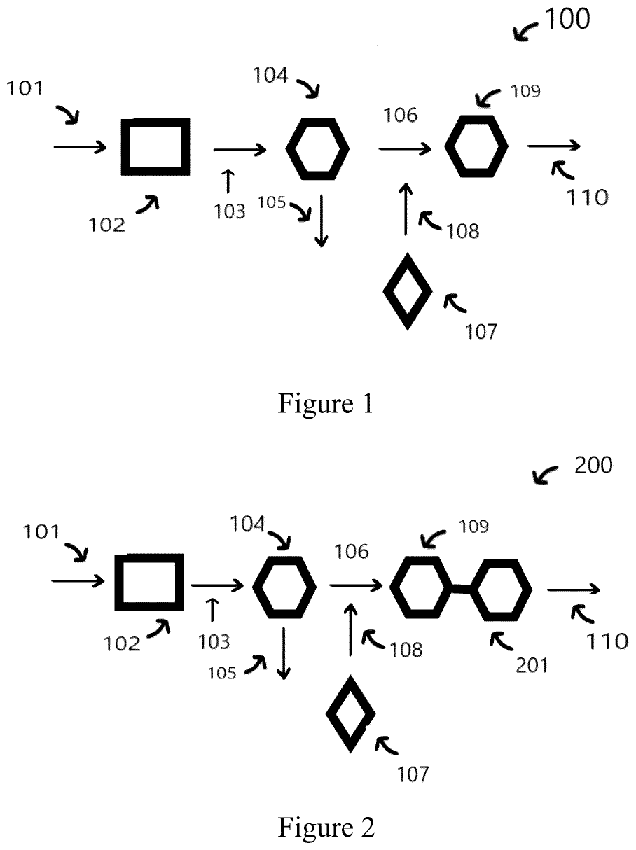

Turning now to the drawings, a first configuration of an embodiment of the application (100) is illustrated in FIG. 1. In this configuration a feed water (101) is introduced into the magnetic flux chamber (102). After being subjected to an intense electromagnetic field of at least 0.8 Tesla, the feed water exits the magnetic flux chamber as partially treated fluid 1 (103) and then enters a phase separator (104) where the partially treated fluid is separated from both light ends and rag (105) which is discarded.

Partially treated fluid 2 (106) is then admixed with an additive (108) from a additive stream or reservoir (107). The partially treated fluid 2 is admixed with additives and then introduced into a filtration system (109). The effluent emerging from the filtration system is then discarded or recycled as needed.

FIG. 2 illustrated a second embodiment of the application (200). Generally speaking, the filtrations systems of the application will normally be the near the end of the systems of the application. Also, more one component of the systems of the application can be used. For example, this illustration shows adding a second filtration system (201). However, any component of the application may be replicated in more than one position in the systems.

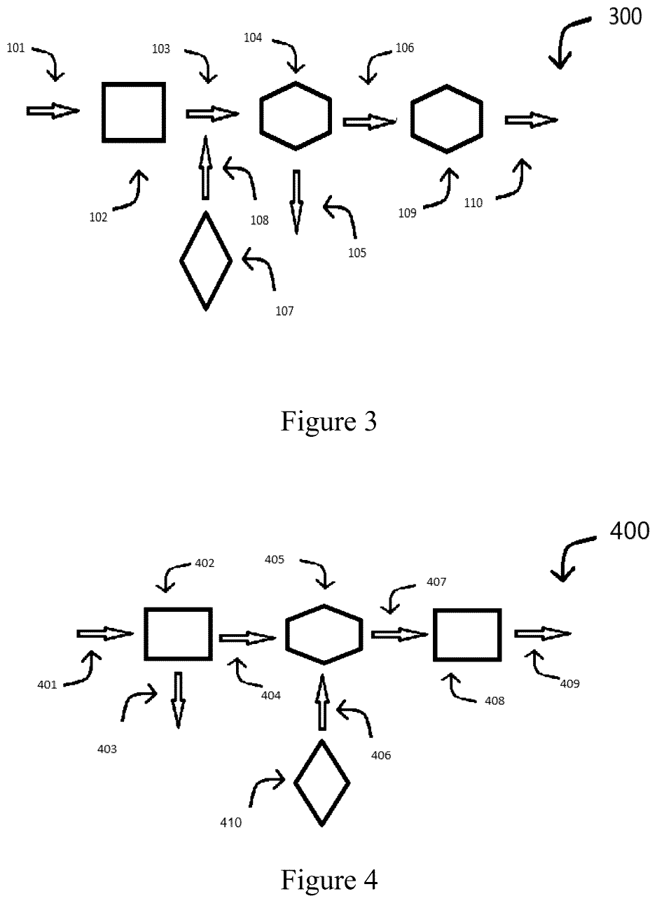

FIG. 3 illustrates a third embodiment of the application (300) where the chemical injection component of the system (107) is configured to introduce additives between magnetic flux chamber (102) and the phase separator (104).

These 3 configurations of the embodiments of the application are useful for treating most kinds of waste water, but are particularly useful for removing the waste streams from a polyolefin unit. They are also useful for removing particulates from waste streams where the waster particulates include a metal component.

FIG. 4 illustrates another embodiment of the application (400) which is particularly useful for treating process water. In this embodiment, a recycle stream or fresh make stream of process water (401) is introduced into electrocoagulation device (402). A first waste stream (403), often a floc, is removed from the electrocoagulation device for disposal or recycle. The partially treated process water (404) is then passed on to an oxidizing cavitation device (405). In addition to the electric and or kinetic oxidation occurring, ozone (406) is introduced into the process water employing at least one ozone injector (410). The partially treated effluent from this part of the system (407) is then passed through a filtration system (408) producing treated process water (409).

In the practice of the method of the application, those of ordinary skill in the art will well know how to size and assemble the components disclosed above and claimed herein in view of the availability of space and utilities for the systems in their specific applications. Conventional pumps, sensors, and the like have not been shown to avoid prolixity.

### EXAMPLES

### Example 1: Polyolefin Wast Treatment

A waste water stream having a solids concentration of 984 ppm as measured by the TSS (total suspended solids) analytical method is introduced into a system of the application. The solids include polyethylene plastic particles.

The treatment system consists of a surge tank, a magnetic flux chamber, a single-phase separator configured to capture and separate lighter than water materials. A flocculent chemical is injected into the process stream after (downstream) of the magnetic flux chamber. The water phase from the separator was sent to the media vessels containing activated carbon for final polishing. Samples of the treated water routinely contained less than 2 ppm of TSS. This solids removal system consistently removed 99.8% of the TSS from the incoming untreated water stream.

### Example 2 Process Water Treatment

One embodiment of the application is shown where a process water feed is introduced into a system as that set forth in FIG. 4. The feed had the following properties:
881 ppm TDS (Total Dissolved Solids)
143 ppm TSS (Total Suspended Solids)
9.3 ppm Aluminum
89.8 ppm Calcium

After treatment, the effluent from the system had the following properties:
271 ppm TDS (69% removal)
0 (ND) ppm of TSS (100% removal)
0 (ND) ppm Aluminum (100% removal)
64.8 ppm Calcium (27.8% removal)

### Example 3 Cooling Water Treatment

Another embodiment of the application is shown where a cooling water source is introduced into a system as set forth in FIG. 4 The source water has the following properties:
Conductivity 2020
1430 ppm TDS

After a single pass treatment, the effluent had the following properties:
Conductivity 1243 (38.4% reduction)
881 ppm TDS (38.3% reduction)

In a multiple pass treatment as configured for a cooling tower basin treatment system, one skilled in the art would expect sequential reductions in both the conductivity and TDS as this percentage removal would continue since most of the cooling water volume is recirculated except for a small percentage of added makeup water, which is NOT high in conductivity or TDS.

What is claimed is:

1. A solids removal system for use with waste and/or process water comprising:
at least one magnetic flux chamber;
at least one phase separator configured to capture lighter than water materials and interfacial rag materials;
at least one chemical injection apparatus; and
a filtration system employing a filtering media,
wherein the at least one magnetic flux chamber, at least one phase separator, at least one chemical injection apparatus and the filtration system is configured to remove solids from the wastewater and/or process water.

2. The system of claim 1 wherein the system has a second phase separator.

3. The system of claim 1 wherein the system is configured as set forth in FIG. 1.

4. The system of claim 2 wherein the system is configured as set forth in FIG. 2.

5. The system of claim 1 wherein the system is configured as set forth in FIG. 3.

6. A method for removing solids from waste water or process water including: employing a magnetic flux chamber within an aqueous process stream to separate at least some solids from the aqueous process stream thereby creating a polarized stream; introducing the polarized stream into a phase separator and diverting any lighter than water materials and rag from the polarized stream; injecting water treatment chemicals into the aqueous process stream at least one point to improve solids and/or lighter than water removal; and passing the treated aqueous process stream through a filter system employing a media sufficient to remove any solids larger than 0.1 microns in diameter.

7. The method of claim 6 wherein the media is sufficient to remove any solids greater than 0.05 microns in diameter.

8. The method of claim 7 wherein the media is sufficient to remove any solids greater than 0.01 microns in diameter.

9. The method of claim 1 wherein the wastewater or process water is waste water.

10. The method of claim 9 wherein the wastewater is effluent form a polyolefin plant.

11. A solids removal system for use with waste and process water including: an electrocoagulation device; at least one ozone injector; an oxidizing cavitation device; and a filtration system employing a filtering media, wherein the electrocoagulation device, at least one ozone injector, oxidizing cavitation device, and filtration system is configured to remove solids and other contaminants from the waste or process water.

12. The solids removal system of claim 11 wherein the system is configured as set forth in FIG. 4.

13. A solids removal process for use with process water comprising: introducing a process water stream into an electrocoagulation device; directing an effluent from the electrocoagulation device an oxidizing cavitation device; and directing the effluent from the oxidizing cavitation device into a filtration system employing a filtering media, wherein: ozone is injected into the process at least one point; and the effluent from the filtration system is recycled into a process where the process is the same or different from that which the process water was initially diverted.

14. The method of claim 13 wherein the process water is cooling tower water.

15. The method of claim 14 wherein the process water is that used to make steam.

16. The method of claim 11 wherein the method removed more than 99.0% of total suspended solids from the process water.

17. The method of claim 16 wherein the method removed more than 99.5% of total suspended solids from the process water.

18. The method of claim 17 wherein the method removed more than 99.8% of total suspended solids from the process water.
